(19) United States
(12) Patent Application Publication
(10) Pub. No.: US 2005/0084561 A1
(43) Pub. Date: Apr. 21, 2005

(54) Ejector device for core box with distribution of demoulding agent

(76) Inventor: Agustin Arana Erana, Vitoria-Gasteiz (ES)

Correspondence Address: KATTEN MUCHIN ZAVIS ROSENMAN, 575 MADISON AVENUE, NEW YORK, NY, 10022-2585, US

(21) Appl. No.: 10/941,776

(22) Filed: Sep. 15, 2004

(30) Foreign Application Priority Data
Sep. 16, 2003 (ES) P200302152

(51) Int. Cl. B29C 45/40

(52) U.S. Cl. 425/444

(57) ABSTRACT

It is applicable to foundry core boxes (4) and has a twofold purpose, on one hand it facilitates the extraction of the mould conformed in the core box and on the other it acts as a distributor in the closed core box of the demoulding agent used to facilitate the extraction of the mould.

It consists of an ejector plate (1) which is constituted by two pieces between which a chamber (8) is established from which the demoulding agent is distributed driven from an external system toward some axial holes (9) drilled in some ejectors (3) which are displaced integrally with the ejector plate (1) and are introduced in the closed core box (4) where they distribute only and uniformly the demoulding agent on the walls of its interior cavity (7) the contamination of other surfaces or mechanisms and the pollution of the atmosphere being avoided.

### OBJECT OF THE INVENTION

The present invention relates to an ejector device applicable to core boxes which has complementarily the function of distributing the demoulding agent habitually employed to facilitate the demoulding of the cores produced.

It is an object of the invention to achieve a precise application of the demoulding agent inside the core box and to this end the application of the demoulding agent is carried out when the core box is closed, whereby uniform distribution is guaranteed of the demoulding agent on the interior surface of the core box, thus avoiding its loss into the atmosphere or the contamination of other parts of the box, for example the partition joint, or parts of the machine adjacent to the core box. It concerns, in a word, having a device which allows the application of the demoulding agent solely on the surface which requires it, in order to obtain a better production yield and improved quality in the cores obtained.

It is also an object of the invention that to carry out the distribution of the demoulding agent with the core box closed, recourse is had to the employment of a device with access to the internal cavity of the core box, as is the case of this ejector device, which suitably adapted also facilitates the flow of demoulding agent through the interior thereof and its distribution in the closed core box.

### BACKGROUND OF THE INVENTION

Core boxes are made up of two or more pieces or frames which are coupled to each other to constitute a cavity in which the mixture of sand and binder is introduced which has to conform the cores, the sand being usually introduced with the help of a blowing plate which is mounted previously on the core box.

It is standard practice that before introducing, blowing, of the sand which has to conform the cores, the interior walls of the core box are sprayed with a demoulding agent to prevent the cores from sticking to the walls of the cavity and to facilitate the demoulding or extraction of the cores once hardened or cured with the help of the ejector mechanism.

At the present time the application of the demoulding agent is done with the core box open, so that by means of a pressurised spraying device the demoulding agent is distributed, which is applied not only on the cavity or print of each frame, but also demoulding agent is sprayed on the partition joint of the two frames and other adjacent parts of the box, causing a number of problems which are detailed hereafter.

The spraying of the demoulding agent on the partition joint, gives rise to the formation thereon of a kind of crust constituted by the demoulding agent and sand grains and powder, which results in the cores fabricated with the dirty mould having burrs and being dimensionally out of tolerance.

The efficiency of the demoulding agent is very low, because a great part of the same is lost into the atmosphere, polluting it, and contaminating areas other than the internal cavity of the mould.

When the demoulding element has been applied, the blower head is attached with its blowing plate to the mould box, the blowing of the sand to the interior of the core box then taking place.

Next, after blowing the sand, the blowing plate is withdrawn and the gassing hood or plate is introduced for distributing the gas which contributes to the hardening of the cores. Finally the ejector plate is introduced which is equipped with some ejectors of a size and distribution in correspondence with the characteristics of the cores which have to be demoulded or ejected.

The cycle recommences with the application of the demoulding agent to the box.

It is also necessary to point out that losses of demoulding agent take place and consequently production efficiency turns out to be very low.

In connection with the ejector device used in the foundry core boxes, it is envisaged that this be constituted by an ejector plate which has some ejectors in correspondence with some openings made in some of the frames through which said ejectors penetrate to push the core formed in the interior thereof. The plate is provided with vertical displacement produced by the action of a hydraulic cylinder for the insertion or extraction of the ejectors.

### DESCRIPTION OF THE INVENTION

The ejector device which this invention discloses has been suitably adapted to offer a twofold function, on one hand it acts as ejector of the cores conformed in the core box and, on the other, it acts as demoulding agent distributor with the core box closed.

Distribution of the demoulding agent is carried out so that the product is only sprayed on the interior cavity of the core box, that is only on the surface which requires it, whereby the problem described above is resolved and the contamination of other surfaces with demoulding agent is avoided, pollution of the atmosphere is avoided, and also demoulding agent consumption is controllable, stoppages for cleaning are fewer, and the dimensional and formal quality of the cores improve substantially.

As is known, the ejector device consists fundamentally of a plate, some ejectors attached to this plate and a mechanism for vertical displacement of the plate which provides the thrust on the mould through the ejectors for extraction of the cores in its function of ejector device.

Based on this basic constitution and with the object of achieving the distribution of demoulding agent, the ejector device comprises an upper ejector plate, displaceable in the vertical direction, is constituted by two pieces between which a chamber is established from which the demoulding agent is distributed to the ejectors and from these to the interior cavity of the mould through axial holes drilled therein, which ejectors can have or not on their free extremity a filter or simply mouthpieces, and which are displaced integrally with the ejector board and are introduced in the closed core box for spraying the demoulding agent only on the interior surface of the mould.

The chamber of the upper ejector plate is connected by means of a tubular conduit which runs from the rear of the plate and perpendicular thereto and is connected by a hose or the like to a system of feeding demoulding agent under pressure.

This tubular conduit is guided during the displacement of the ejector plate, next to a vertical axle which likewise runs from behind and perpendicular to the ejector plate, with respect to sockets joined to the bed plate of the core box, the vertical axle and the tubular conduit being linked by means of an upper plate to which a vertical hydraulic cylinder is applied which causes the up or down displacement of the ejector plate determining the introduction or extraction of the ejectors into or from the interior of the core box.

Once the demoulding agent has been sprayed, the extractor plate is withdrawn to give way to the blowing plate and to the gassing dome or plate, which sequentially will enter into operation in the process of fabricating the cores in order to, once the cores are cured, achieve the extraction thereof with the intervention of the extractor plate which therefore comes into play in two phases of the process: in the phase of applying demoulding agent and in the phase of extracting cores.

When the cores have been conformed inside the core box, their extraction will proceed with the help of the ejector device through the thrust of the ejectors on the mould.

### DESCRIPTION OF THE DRAWINGS

To complete the description that is being made and with the object of assisting in a better understanding of the characteristics of the invention, in accordance with a preferred example of practical embodiment thereof, accompanying said description as an integral part thereof, is a set of drawings wherein by way of illustration and not restrictively, the following has been represented:

FIG. 1.—It shows a view in cross-section of the core box with gassing chamber in which the upper ejector device is seen in the operative position of the demoulding agent inside the closed core box.

FIG. 2.—It shows a view in cross-section of the core box but, in this case, with gassing plate instead of gassing chamber, the constituent elements being likewise observed of the core ejector device and applicator of demoulding agent.

### PREFERRED EMBODIMENT OF THE INVENTION

The ejector device for core box with distribution of demoulding agent which constitutes the object of this invention is based fundamentally on the incorporation of an ejector plate (1) mounted on a structure vertically displaceable through the action of a hydraulic cylinder (2), from which some ejectors (3) extend frontally and perpendicularly which are introduced in some openings (5) defined in one of the frames (6) of the core box (4) for extraction of the cores conformed in the interior cavity (7) of the core box (4).

Starting from this basic constitution the ejector device is distinguished fundamentally because the upper ejector plate (1) is constituted by two pieces between which a chamber (8) is established from which the demoulding agent is distributed which is fed under pressure from an external pump to some axial holes (9) drilled in the ejectors (3), which are displaced integrally with the ejector plate (1) and are introduced in the closed core box (4) wherein they distribute only and uniformly the demoulding agent on the walls of the interior cavity (7) thereof avoiding the contamination of other surfaces or mechanisms and the pollution of the atmosphere, it being foreseen that the chamber (8) of the ejector plate (1) communicates, by means of a tubular conduit (10) which runs from the rear and perpendicular to the ejector plate (1), with a hose connected to a demoulding agent feeding system.

The ejectors can have some mouthpieces or a filter (17) on their free extremity.

The displaceable structure on which the plate is mounted consists of the tubular conduit (10), a vertical displacement axle (11) which runs from the rear of and perpendicular to the ejector plate (1) and an upper plate (12) which links them and upon which the hydraulic cylinder (2) acts which causes the vertical displacement of the upper plate (12) and integrally of the tubular conduit (10) and of the vertical displacement axle (11) with respect to corresponding sockets (13) of the dome (14) of the core box (4), and also it determines the integral displacement of the ejector plate (1) with its ejectors (3) for introduction or extraction thereof into or from the core box (4).

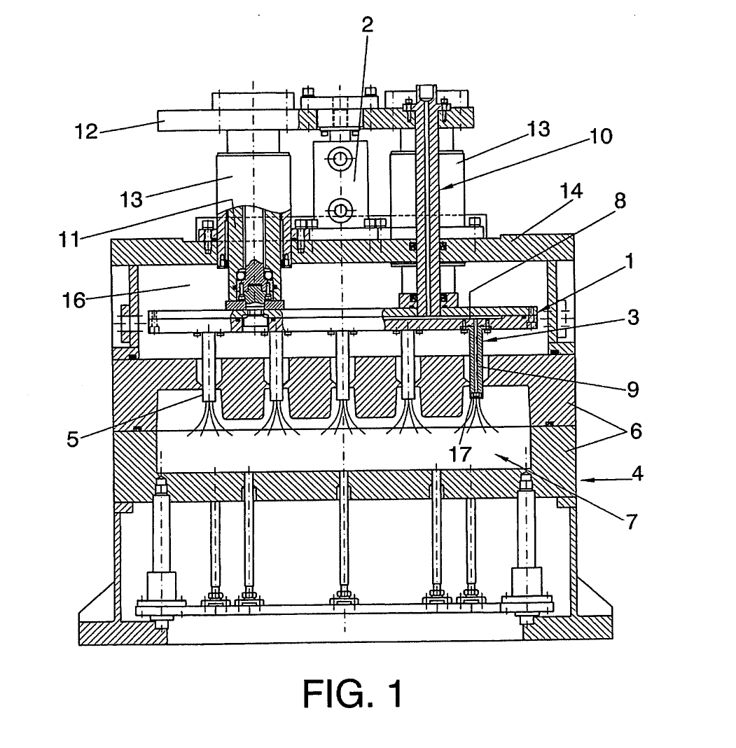

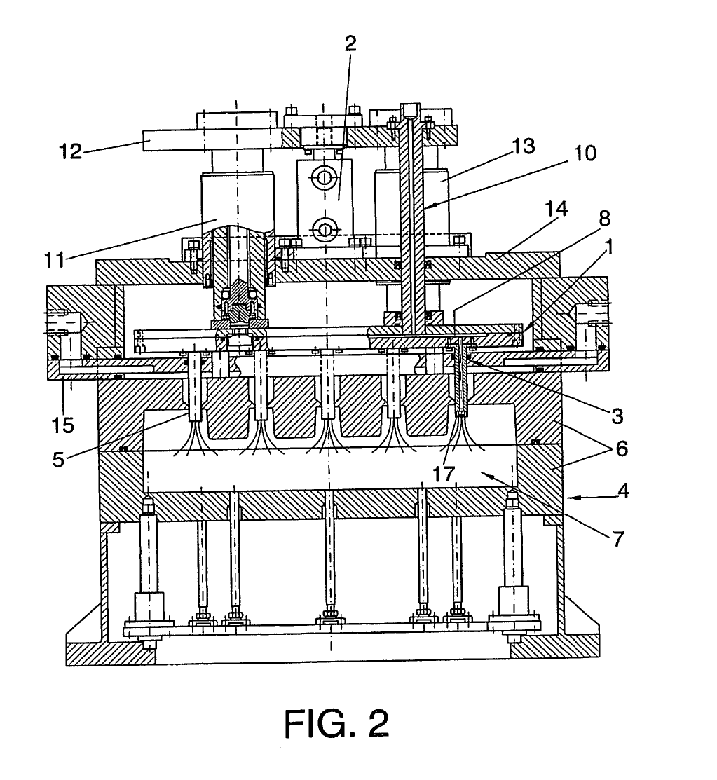

In FIG. 1 the device object of the invention appears mounted on a core blowing machine which has a gas chamber (16). In FIG. 2 the machine is equipped with a gassing plate (15). From the gassing chamber (16) or through the gassing plate (15), the gas is directed into the core box in the gassing phase thereof.

As indicated above, once gassing has taken place and the cores are cured, the extraction thereof will proceed and the ejector plate again comes into play acting as such in this phase of the process.

1. Ejector device for core box with demoulding agent distribution which is based on the use of an ejector plate (1) mounted on a structure vertically displaceable through the action of a hydraulic cylinder (2) from which extend frontally and perpendicularly some ejectors (3) which are introduced in some openings (5) defined in one of the frames (6) of the core box (4) for extraction of the cores conformed in the interior cavity (7) of the core box (4), characterised in that the application of the demoulding agent is carried out with the box being closed, using the actual ejector plate (1) which is constituted by two pieces between which a chamber (8) is established from which the demoulding agent is distributed fed from an external system toward some axial holes (9) drilled in the ejectors (3), which are displaced integrally with the ejector plate (1) and are introduced in the closed core box (4) where they distribute only and uniformly the demoulding agent on the walls of its interior cavity (7), it being foreseen that the chamber (8) of the ejector plate (1) communicates, by means of a tubular conduit (10) which runs from the rear of and perpendicular to the ejector plate (1), with the external system that delivers under pressure the demoulding agent.

2. Ejector device for core box with distribution of demoulding agent according to claim 1 characterised in that the ejectors have a filter (17) or nozzle on their free extremity.

3. Ejector device for core box with distribution of demoulding agent according to claim 1 characterised in that the ejectors have a mouthpiece on their free extremity.
